(19) United States
(12) Patent Application Publication
(10) Pub. No.: US 2008/0260264 A1
(43) Pub. Date: Oct. 23, 2008

(54) Method and system for generating aesthetic characters, and business model of the same

(76) Inventors: Kohei Miura, Saitama-ken (JP); Kouzaburou Furukawa, Tokyo (JP); Atsumu Yokoishi, Chiba-ken (JP); Akira Itoh, Tokyo (JP); Yukiko Okada, Tokyo (JP); Hajime Hasegawa, Tokyo (JP)

Correspondence Address: REED SMITH LLP, Suite 1400, 3110 Fairview Park Drive, Falls Church, VA, 22042, US

(21) Appl. No.: 11/785,550

(22) Filed: Apr. 18, 2007

(51) Int. Cl. G06K 9/68

(52) U.S. Cl. 382/226

(57) ABSTRACT

The present invention relates to a method and system for generating aesthetic characters, and to a business model for commercially developing the method and system utilizing the Internet or the like. The present invention makes it possible to synthesize a variety of image patterns with arbitrary characters by adding stroke fonts. According to a first aspect, the present invention provides a method and system for generating aesthetic characters, in which an arbitrary image pattern is selected from a pattern database, and data on arbitrary characters constituting single lines are superposed on the selected image pattern, whereby the arbitrary image patterns are processed into various characters and generating aesthetic image patterns. Thus, it is possible to provide character bodies drawn with excellent aesthetic properties that are uniquely designed for attracting public attention, such as in the television broadcasts, Internet sites, headings of journals or newspapers, advertisements, and signboards.

### BACKGROUND OF THE INVENTION

1. Field of the Invention

The present invention relates to a method and system for generating aesthetic characters by using an electronic apparatus, and also relates to a business model for commercially developing the method and system by utilizing the Internet line or the like.

2. Description of the Related Art

For example, in the latest television broadcast, characters uniquely and showily designed for attracting public attention are used for a title of the top section of a program, and a telop and flip which provide an effect in the program.

In addition to the television broadcast, such designing is conducted for all characters used for contents of a site on the Internet utilized by groups/individuals or the like, and characters used for a heading and a title of a journal, a newspaper, an advertisement, a signboard or the like. Obviously, it is commonly recognized that the unique and showy character styles are considered to be used in a part which is desired to be emphasized.

For example, if in producing a television program entitled “Special Edition of Beetles”, title characters broadcasted on the heading screen of the program have a form constituted by an illustration of beetles or associated with the contents of the program, the title characters inevitably provide a great impact to the viewers so as to strongly attract their interest in the program.

Likewise, in the cases where a logo made by arranging flowers and plants in suitable places in characters is displayed as a signboard in a flower shop, where the heading of an advertisement of a festival is made by a motif of a portable shrine, or where the name portion of a name card is made by a motif of a portrait of the owner of the name card, any of these cases undoubtedly exhibits remarkable effects on the original purpose of giving a strong impression to the others.

Therefore, it is a major object of the present invention to propose a method and system for generating aesthetic characters, in which without the use of a system font, a stroke font is displayed to so as be recognized as a Bezier curve, and then subjected to processing so as to be graphically synthesized with an image pattern, and also to provide a business model of the method and system.

Therefore, the present invention is characterized by making it possible to synthesize even a wide variety of image patterns with arbitrary various characters by adding the stroke fonts. In other words, in the Windows, Macintosh OS or the like, in which a dedicated font creating program is utilized, only outlined characters of true-type or the like are recognized as the system font, and hence, the above described graphic synthesizing processing cannot be performed on almost all personal computers at present. However, according to the present invention, it is possible to perform such graphic synthesizing processing.

A specific objects of the present invention is to propose a method and system for instantaneously generating aesthetic characters in which single lines and various image patterns are synthesized with each other, by using an electronic apparatus. A further object of the present invention is to provide a system which can be easily operated by everyone, and to which even an image pattern made by a user or member of the system can be easily inputted.

A further object of the present invention is to propose a method and system, and a business model of the same, for making it possible that a desired image pattern is easily selected from enormous kinds of image patterns inputted in the above described database, that an image pattern no longer used is deleted from the database or modified, that various image patterns obtained by graphically representing motifs themselves or the like, besides video images of all of real objects existing in the natural world and various rough sketches and illustrations of the real objects, are stored in the above described pattern data of various image patterns, and data relating to hobbies or the like of everyone regardless of age or sex as well as everyone engaged in all occupations are included in the pattern data, so as to make it possible to generate aesthetic characters in a extremely wide range of utilization fields.

A further object of the present invention is to provide a system which makes it possible to apply not only Japanese and English but also a language of any country as the language enabling aesthetic characters according to the present invention to be generated, which makes it possible to apply a general purpose apparatus to output the character bodies without the need of dedicated output means, and which is capable of successively displaying the creating process of the characters on a monitor by dynamic means, and thereby drawing great interests from viewers of the monitor.

### SUMMARY OF THE INVENTION

According to a first aspect of the present invention, there is provided a method for generating aesthetic characters, in which an arbitrary image pattern is selected from a pattern database in which various patterns are stored, and data of arbitrary various characters constituted of single lines are superposed on the selected image pattern, whereby the arbitrary image pattern are processed into arbitrary various characters, so as to generate and output an aesthetic image pattern. According to a second aspect of the present invention, there is provided a system which includes: means for selecting an arbitrary image pattern from a pattern database in which various image patterns are stored; means for superposing data of arbitrary various characters constituted of single lines on the selected image pattern; and means for processing the selected arbitrary image pattern into various arbitrary characters, and which enables desired image pattern characters and/or desired fonts to be generated and outputted.

Further, according to a third aspect of the present invention, there is provided a business model which includes: means for selecting an arbitrary image pattern from a pattern database in which various image patterns are stored; means for superposing data of arbitrary various characters constituted of single lines on the selected image pattern; means for processing the selected arbitrary image pattern into arbitrary various characters; means for generating and outputting an aesthetic image pattern; a front server having an original list on the basis of which registration of a user or member and payment of the price in relation to the aesthetic image pattern are performed, and having the data of various image patterns; and a terminal of the user or member having a function which enables an image pattern created by the user or member to be inputted into the pattern data of various image patterns in the front server. According to a fourth aspect of the present invention, the front server includes a generator application of fonts or the like besides the pattern data of various image patterns, enables the image pattern created by the user or member to be inputted into the pattern data of various image pattern in the front server by using the Internet or the like, performs image processing for converting the data of the image pattern by the application of an image pattern through a stroke font or the like with the generator application, or the like, and enables the processed image to be converted in the front server and delivered to terminals such as a PC of the user or member according to an access by the user or member.

Further, according to a fifth aspect of the present invention, in addition to the above described aspects, the user or member is a user of the system, and at the same time, a creator who inputs pattern data of various image patterns into the front server. Further, according to a six aspect of the present invention, in addition to the above described aspects, an arbitrary image pattern inputted into the above described pattern database is provided with a code based on a fixed rule such as classification by fields relating to the image patterns, so as to enable an image or the like to be outputted on the basis of the code. According to a seventh aspect of the present invention, in addition to the above described aspects, the pattern data of arbitrary image patterns inputted into the above described pattern database are hierarchically classified and registered for each pattern data of image pattern, and are registered in such a manner that when an arbitrary pattern is retrieved from the pattern data, a plurality of initial sounds of words meaning the pattern can be retrieved.

Further, according to an eighth aspect of the present invention, in addition to the above described aspects, there is further provided database maintenance means which enables a newly created image pattern to be registered, and also enables, among arbitrary image patterns inputted into the above described pattern database, an image pattern no longer used to be deleted from the pattern database or to be modified. According to a ninth aspect of the present invention, in addition to the above described aspects, for example, chargeable image patterns shared only by a group of specific users or members such as copyright holders, and image patterns for nonchargeable groups are registered in the image patterns registered in the above described pattern database of image patterns, and the users or members of each group are allowed to selectively utilize only the image patterns of the pattern database, which are allowed for the group. According to a tenth aspect according to the present invention, the pattern data of various images include motifs themselves besides video images of real objects and various rough sketches and illustrations of the real objects, and also include graphics or the like which are classified into the fields of living matters and the nature, and are represented in conjunction with various plants, animals, human being, and graphics or the like which are classified into the field of technology, and are represented in conjunction with various electronics besides computer apparatuses, the Internet and technologies. According to an eleventh aspect of the present invention, the above described various characters can be applied to the language currently used in every country in the world, and further include characters which are subjected to the emphasizing processing and half-tone dot meshing processing and provided with a side point and a ruby, enclosed characters, and various decorative and colored characters.

Further, according to a twelfth aspect of the present invention, besides various printers and facsimiles, a computer apparatus of a portable type, a desktop type or a mobile type, a portable telephone, a PHS, or a user or member's terminal of a stationary type such as PDA (Personal Digital Assistants) can be applied to an apparatus capable of outputting various characters, as means for outputting the above described aesthetic character bodies. According to a thirteenth aspect of the present invention, stroke font data exclusive for the pattern data processing of the various image patterns are used for the above described pattern data of various image patterns. According to a fourteenth aspect of the present invention, the above described means for superposing (synthesizing) data of arbitrary various characters constituted of single lines on the various image patterns, enables the synthesizing process to be displayed on a monitor of a PC or the like by dynamic images.

According to a fifteenth aspect of the present invention, when the above described arbitrary image pattern is selected, a plurality of arbitrary image patterns are selected, and data of arbitrary various characters constituted of single lines are superposed on the plurality of arbitrary image patterns. According to a sixteenth aspect of the present invention, the above described means for selecting the arbitrary image pattern and superposing the selected image pattern on data of arbitrary various characters, enables a part of the image pattern to be arranged at a desired position of the characters. According to a seventeenth aspect of the present invention, an arbitrary image pattern is formed into a continuous and/or discontinuous arbitrary image pattern by the aesthetic character bodies drawn by the above described system. According to a eighteenth aspect of the present invention, the above described aesthetic character bodies are formed in such a manner that all or part of the arbitrary various characters is formed into an arbitrary image pattern.

Thus, according to an advantage of the present invention, it is possible to provide character bodies which are excellently drawn in the aesthetic property, and which are uniquely and showily designed for attracting public attention, so as to be used, for example in the television broadcast, for a title of the top section of a program, and a telop and flip for providing an effect in the program. Further, the processing for providing such character bodies can be performed for all characters used in contents of a site or the like on the Internet utilized by various groups or individuals, and in a heading and a title of a journal, a newspaper, an advertisement, a signboard, or the like, as a result of which the unique and showy characters can be used in respective parts which are desired to be emphasized.

A further advantage of the present invention is that even an image pattern created by a user or member of the system can be easily inputted and stored in the system, that retrieving means is devised so as to enable, when desired by the user or member, an arbitrary image pattern to be immediately retrieved from image patterns stored in the pattern database (server) of the system, and that the retrieving operation can be performed by the retrieving means on the basis of a plurality of initial sounds of words, and thereby quickly and surely performed. In addition to such advantages, according to a further advantage of the present invention, the arbitrary image patterns are classified into high order concepts, synonyms and lower order concepts in a manner of a so-called thesaurus, which facilitates the narrowing down into a desired image pattern.

A further advantage of the present invention is that arbitrary image patterns not retrieved (not used) for a fixed period of time can be deleted from the pattern database (server), and on the contrary, image patterns such as those reflecting the age can be easily inputted, that in the case where the image patterns are chargeable due to the copyright or the like, the system notifies the user or member of the existence and the price of such image patterns, so as to enable the user or member to select the image patterns with ease, and that intangible motifs such as those created by using the peace as a theme, or the like, are stored in the pattern database, besides image patterns of tangible articles in all fields.

A further advantage of the present invention is that although ordinary characters of the currently used languages are constituted by the combination of single lines or by a single complicated curve, characters according to the present invention are constituted on the basis of single lines, and hence can be applied to languages in as many countries as those throughout the world. The above described means for outputting aesthetic character bodies, according to the present invention, makes it possible to obtain an output screen or a hard copy which is particularly excellent in colors, by using PHS, PDA, or the like, as well as various printers and facsimiles, and can be applied, besides such apparatuses, to an apparatus capable of outputting various characters such as a user or member's terminal of a portable type, a desktop type, a mobile type, or a stationary type. Further, the pattern data processing of various image patterns, according to the present invention, can be quickly and accurately performed by the use of the dedicated stroke font data, and makes it possible for the user or member to view, on a monitor of a PC or the like, the process in which the image patterns and single lines are successively changed into aesthetic characters in such a manner that the image patterns and single lines are gradually mixed with each other, and to thereby have great interests in the operation for the process.

In addition to the above described advantages, according to the present invention, when an image pattern is selected, and for example, a character “H” is desired to be made into an aesthetic character, it is possible to obtain an image pattern which is not a mere image of “H”, but an interesting image as if a monkey and a bear were carrying a weakened rabbit, by selecting image patterns of a monkey and a bear for the two upright lines in parallel to each other, and an image pattern of a rabbit for the single line of the horizontal part. For example, by assuming the upright single lines of “H” as “trees”, and making one or more “birds” perch on respective desired places, it is possible to easily obtain an interesting image pattern which is not a mere image of “H” but an image as if trees were standing in a forest. Further, according to the present invention, it is also possible to easily obtain, as such an aesthetic character, an interesting image pattern in which the single line itself is constituted by, for example, flying “airplanes”.

Further, in general, according to the advantages of the present invention, in producing a television program entitled “Special Edition of Beetles”, it is possible to make title characters broadcasted on the heading screen of the program have a form constituted by an illustration of beetles or associated with the contents of the program, thereby providing a great impact to the viewers and strongly attracting their interest in the program.

Further, according to the present invention, by using the aesthetic characters, it is possible to display the characters as a signboard, to make the header of an advertisement of a festival with a motif of a portable shrine, or to make the name portion of a name card with a motif of a portrait of the owner of the name card, with the result that any of these cases undoubtedly exhibits remarkable effects on the original purpose of giving a strong impression to the others.

Note that the present invention is explained mainly in connection with characters of the languages of various countries, but the present invention is not limited to this, the present invention can be applied to symbols, illustrations or the like, constituted by single lines, and such application is also included within the scope of the present invention. Further, the input means of various characters are not limited to the input means of the printing type of a PC, but may also be an autographic input by a touch pen.

### BRIEF DESCRIPTION OF THE DRAWINGS

FIG. 1 is a flow chart of a process for generating aesthetic characters according to the present invention;

FIG. 2 is a block diagram of a system for generating aesthetic characters according to the present invention;

FIG. 3 is a block diagram of a business model of the system for generating aesthetic characters according to the present invention;

FIG. 4 to FIG. 7 show examples obtained by merging arbitrary image patterns into various characters constituted of single lines, and FIG. 4 is an illustration in which an image pattern of “stag beetle” is merged into arbitrary various characters formed of single lines;

FIG. 5 is an illustration in which an image pattern of “cricket” is merged into the arbitrary various characters constituted of single lines;

FIG. 6 is an illustration in which an image pattern of “flower of violet” is merged into the arbitrary various characters constituted of single lines;

FIG. 7 is an illustration in which an image pattern of “flower of calamus” is merged into the arbitrary various characters constituted of single lines;

FIG. 8 is an illustration of an example of aesthetic characters drawn according to the present invention, in which bicycles are arranged;

FIG. 9 is an illustration of an example of an aesthetic character drawn according to the present invention, in which person's hands are arranged;

FIG. 10 is an illustration of an example of aesthetic characters drawn according to the present invention, in which jewels are arranged;

FIG. 11 is an illustration of an example of aesthetic characters drawn according to the present invention, in which a plurality of pieces of coral and shellfish are arranged;

FIG. 12 and FIG. 13 are examples of aesthetic characters drawn according to the present invention, which are constituted particularly by various arbitrary continuously curved characters (such as calligraphic characters), and FIG. 12 is an illustration of aesthetic characters in which “lively moving dragons” are arranged;

FIG. 13 is an illustration of aesthetic characters in which the “feathers of birds” are arranged in consideration of their positions;

FIG. 14 is an illustration of aesthetic characters in which “wheat leafs” and “ears” are arranged in consideration of their positions;

FIG. 15 is an enlarged illustration of a part surrounded by the circle in FIG. 12;

FIG. 16 is an enlarged illustration of a part surrounded by the circle in FIG. 13;

FIG. 17 is an enlarged illustration of a part surrounded by the circle in FIG. 14;

FIG. 18 is an illustration of an aesthetic character providing center; and

FIG. 19 is an illustration of WS.

### DETAILED DESCRIPTION OF THE PREFERRED EMBODIMENTS

In the following, embodiments according to the present invention will be described with reference to the accompanying drawings. For ease of understanding of the present invention, first, typical examples of aesthetic novel characters, which are created by using a method and system according to the present invention, are described.

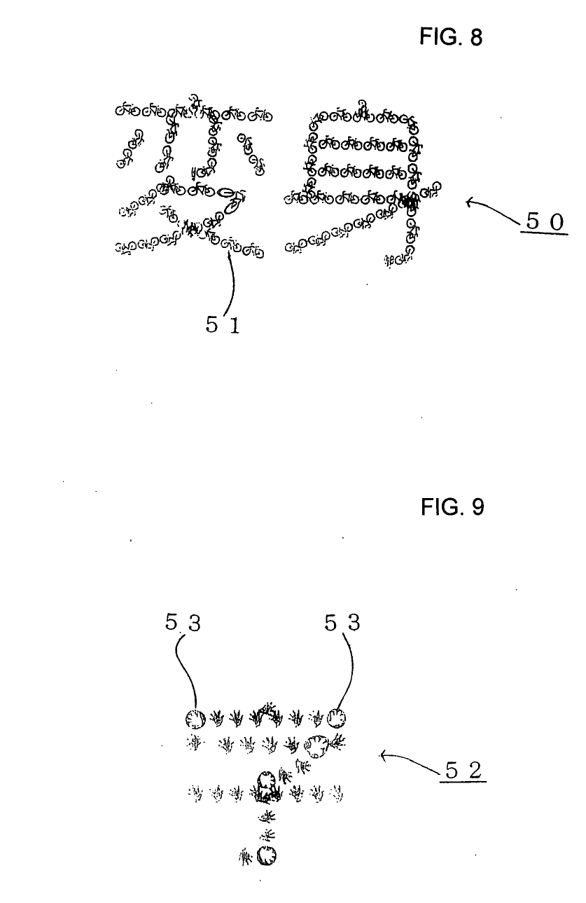

That is, FIG. 8 shows an example in which a number of small image patterns (51) of “bicycle” are continuously arranged on all parts of characters (50) of “Henshin” of Japanese that are constituted of single lines.

Further, FIG. 9 shows an example in which, as described above, a number of small image patterns (53) of “hand” are continuously arranged on all parts of a character (52) of “Ji” of Japanese that are constituted of single lines, but in which white “image patterns of hand” (53) are arranged at folded parts of the character (52) in contrast to the black painted parts of the character (52).

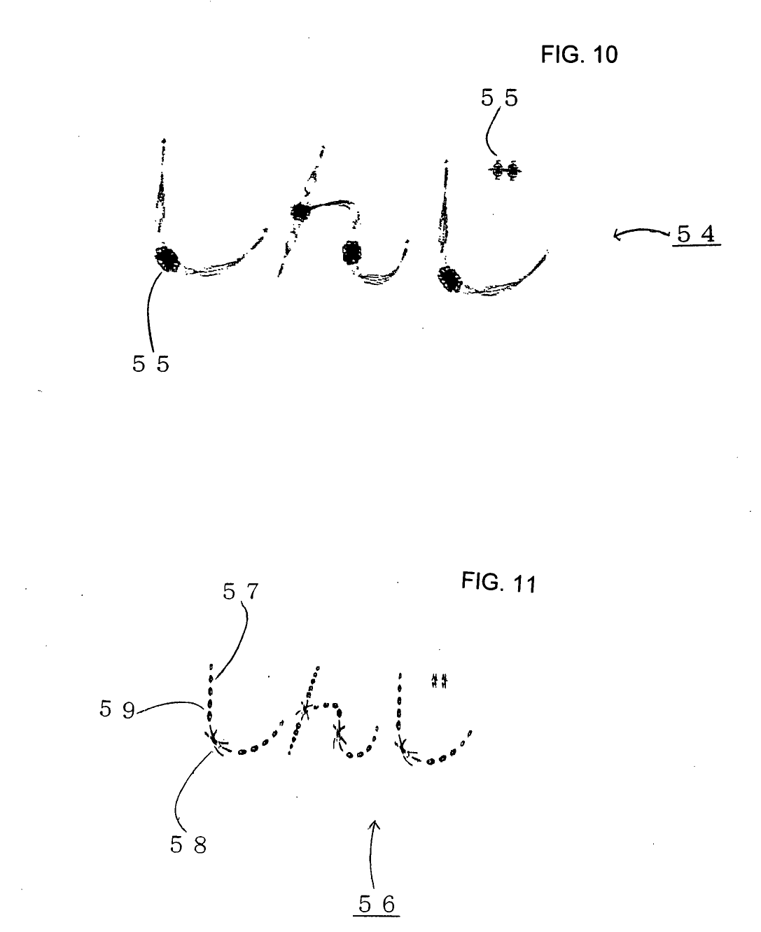

Further, FIG. 10 and FIG. 11 show examples in which a plurality of image patterns (55) of “jewel” are arranged on characters (54) of “Shinji” of Japanese that are constituted of single lines, and in which it is devised to particularly emphasize major part of the jewel.

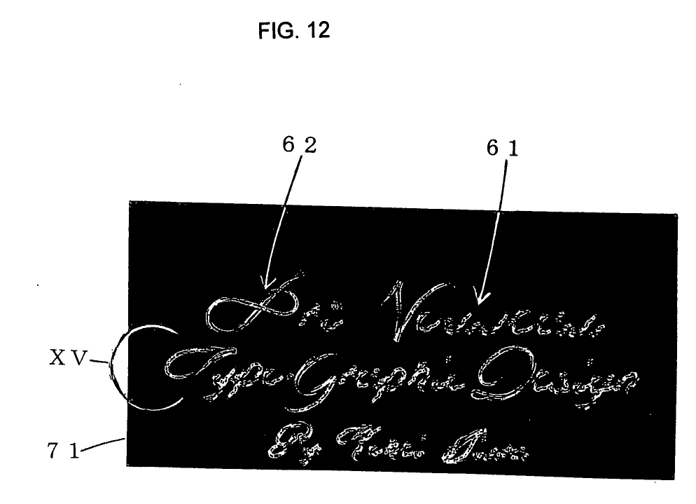

Further, FIG. 12 shows an example in which a plurality of image patterns (60) of coral (58) and shellfish (59) like Sakura-gai are similarly arranged on the characters (56) of “Shinji” of Japanese, but in which the aesthetic property of the characters is enhanced by arranging the plurality of pieces of coral (58) around the shellfish (59) like Sakura-gai.

In this case, characters constituted of single lines are used for “printing type”, so-called “Gothic type” characters and a newspaper. For example, the characters shown in FIG. 12 to FIG. 14 are constituted in particular on the basis of arbitrary continuously curved calligraphic type characters (61). In FIG. 12, English characters (62) constituted of single lines of “ART-NOUVEAUTYPOGRAPHIC DESING BY KOHEI MIURA REVOLU-INC” represent lively moving dragons.

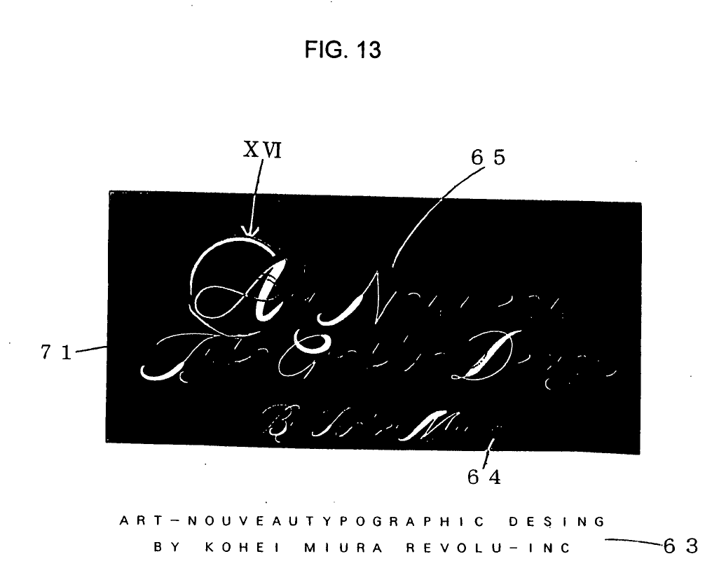

In this case, for the English characters constituted of the single lines of calligraphic type characters, calligraphic type characters need not be drawn or selected beforehand, and known means provided for the system according to the present invention, the detailed explanation of which is omitted, may be instructed so that the English characters are drawn in the printing type (63), and then made into calligraphic type characters (64). That is, in FIG. 13, Gothic type characters of “ART-NOUVEAUTYPOGRAPHIC DESING BY KOHEI MIURA REVOLU-INC” may be preferably made into aesthetic English characters (65) constituted of single lines, in which characters the feathers of birds are arranged in consideration of their positions.

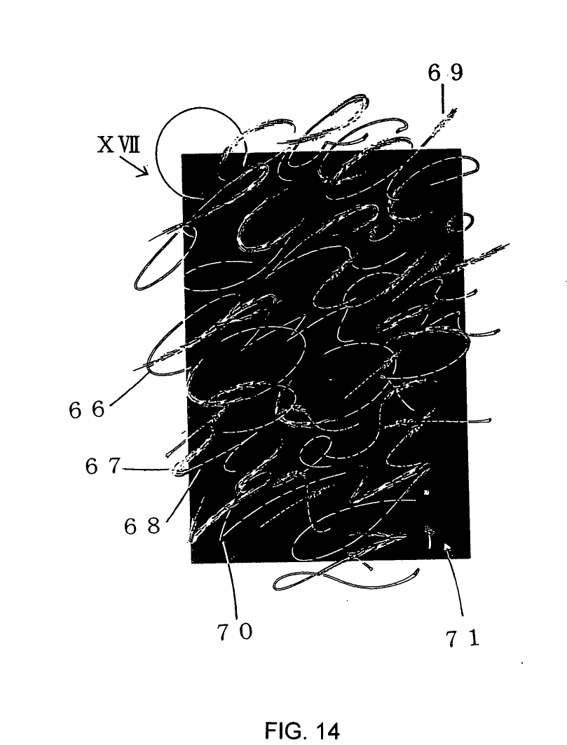

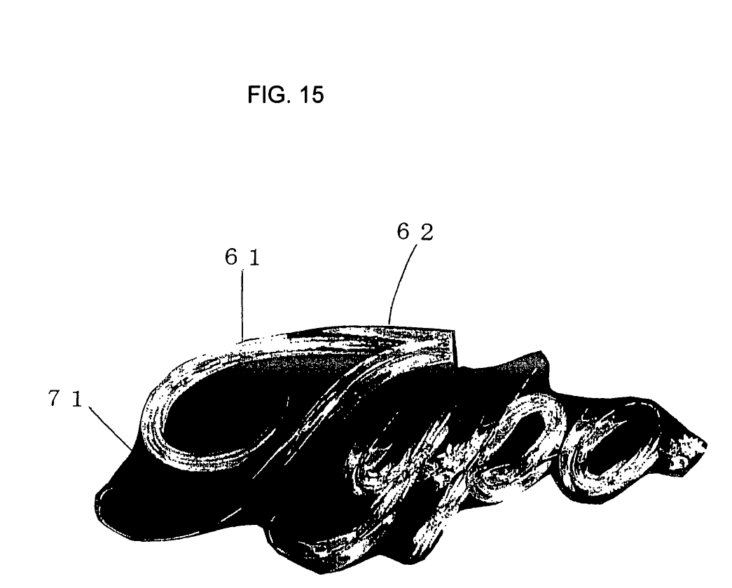

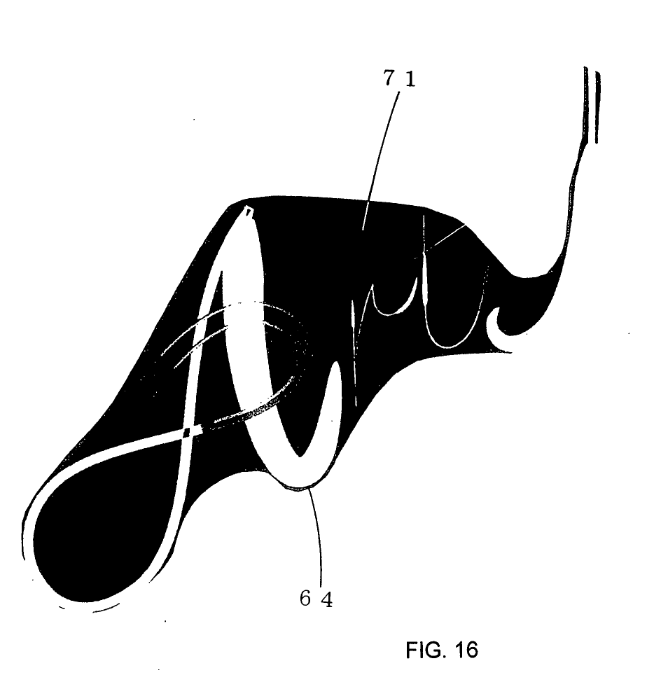

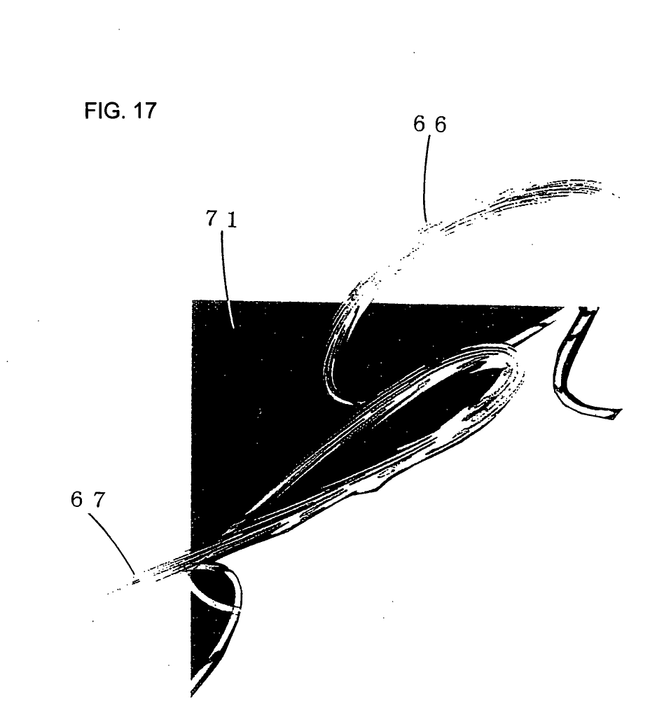

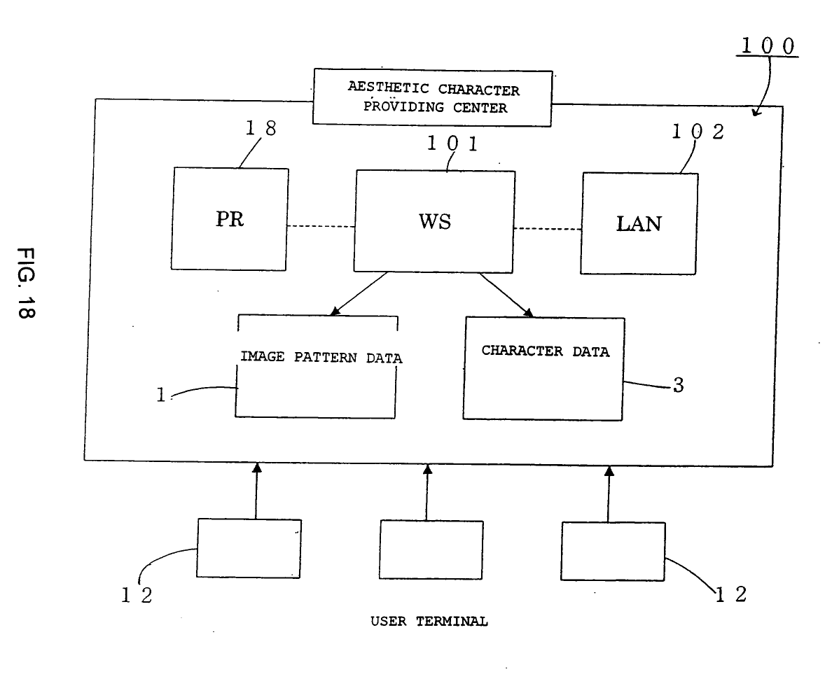

Further, in FIG. 14, printing type alphabetic characters (66) of A to Z inputted into a PC are converted by calligraphic character converting means (not shown and explained) of a PC, so that aesthetic English characters (70) are constituted in consideration of positions of stems (68) and ears (69) of wheat (67). Note that as can be seen in FIG. 12 to FIG. 14, the aesthetic property of the English characters constituted in this manner can be more enhanced by being provided with a colored background or mount (71).

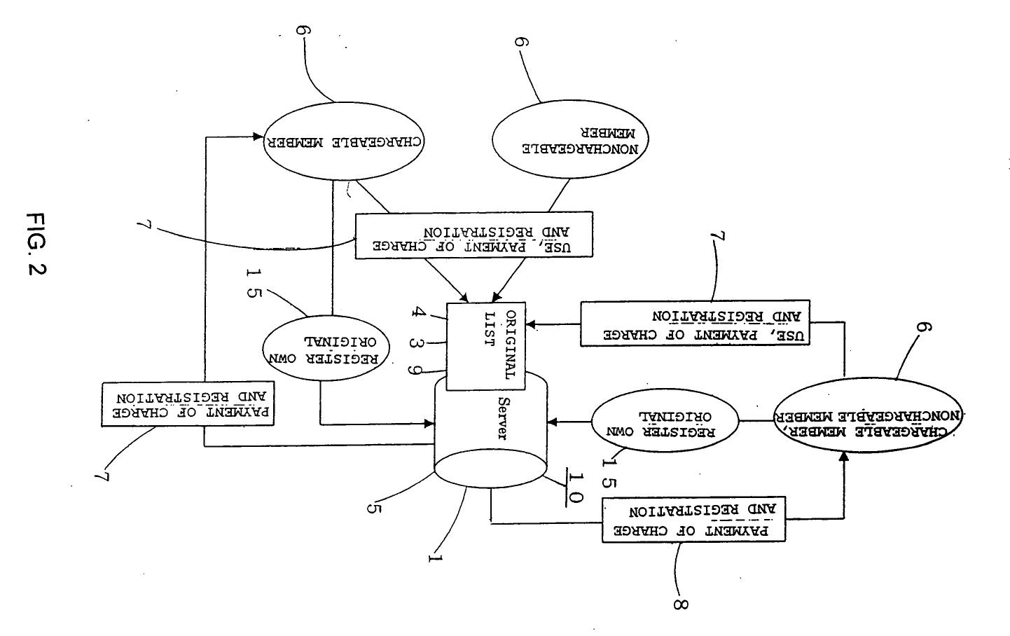

Next, a system for generating the aesthetic characters according to the present invention will be explained. In FIG. 2, reference numeral (10) denotes a main server, which generally stores image pattern data (1) including a number of arbitrary image patterns (2) that are inputted in the main server, and arbitrary various character data (3) including a number of arbitrary various characters (4) that are inputted in the main server. Further, as will be described below, means for selecting an arbitrary image pattern (2) from the stored various image pattern data (1), means for superposing data (3) of arbitrary various characters constituted of single lines on the selected image pattern (2), means for processing the selected arbitrary image pattern (2) into arbitrary various characters (4), and means for generating and outputting desired character bodies (5) are provided in a terminal (12) of a user or member (6) as will be described below, or a host computer (not shown) provided for the above described main server (10).

Further, in the figure, reference numeral (9) denotes an original list of the arbitrary image patterns (2) and the data (3) of arbitrary various characters, which is provided in the main server (10). The main server (10) is provided with a system which when the user or member (6) desires to use character bodies (5) in the system according to the present invention, performs registration and price payment processing (8) or the like.

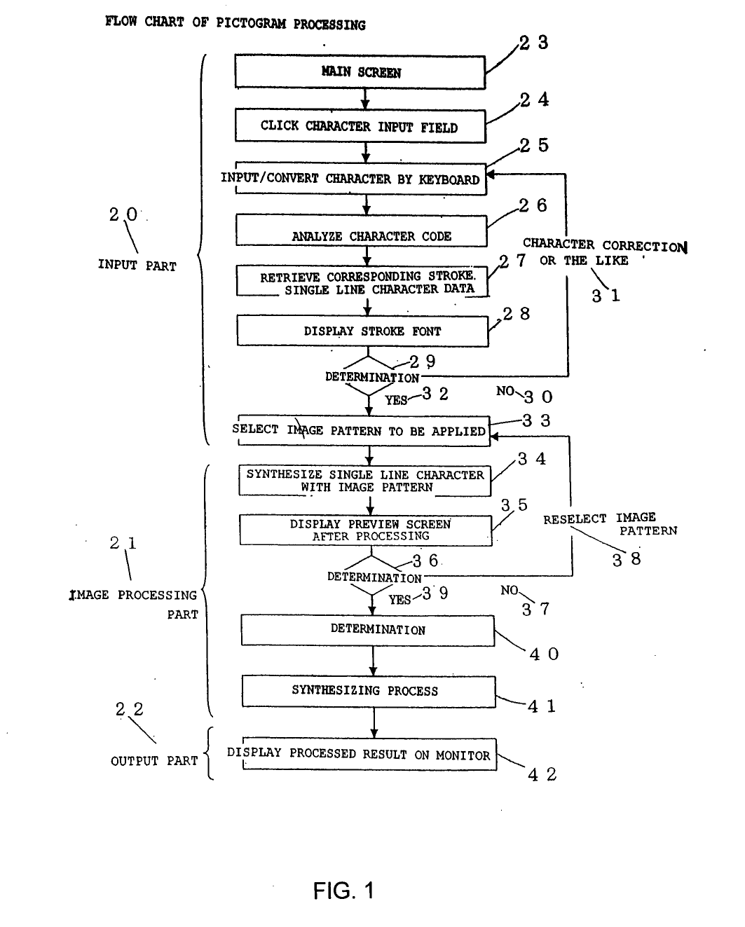

Next, an operation of the system according to the present invention is explained mainly with reference to FIG. 1. First, means for inputting (20) arbitrary various characters (4) and arbitrary image patterns (2) into the main server (10) is explained.

In FIG. 1, reference numeral (23) denotes a main screen in the terminal (12) of the user or member (6), on which a character input field is displayed. The user or member (6) clips (24) this field, and subsequently inputs (25) predetermined various characters (4) by a keyboard to the main server (10) in which languages of various countries are stored as described above.

Thus, when the main server (10) is started by the input of characters performed by the user or member (6), the main server (10) first judges whether or not there are a format converter, a rasterizer or the like, and creates information data on the basis of its service capability, and transmits the information data to a character server broker (a purchaser or a user).

When receiving the information data, the server broker of aesthetic characters extracts the service capability included in the information data, so as to store the service capability in a server state storage section in correspondence with the character server as the transmitting source, and thereafter shifts to a character request waiting state. Next, when such character request is generated, character request data are transmitted to the character server broker. In the character server broker which has received the character request data, a character server selecting section selects a character server to which the character request is performed, on the basis of the service capabilities of respective character servers stored in the server state storage section, and transmits the character request data to the character server selected in this manner.

When receiving the character request data, the character server storing aesthetic characters extracts character data corresponding to the requested characters, so as to perform necessary format conversion and rasterizing processing to the extracted characters, and thereafter outputs the resultant character data to the character server broker.

Further, when receiving the character data transmitted from the character server, the character server broker of aesthetic characters outputs the received character data to the client as the request source of the character data.

As a result, when receiving the character data, the client outputs the character data to a display processing section to use the character data as characters for character display.

Next, an example of a business model according to the present invention is described. In FIG. 18, reference numeral (100) denotes an aesthetic character providing center which provides aesthetic characters. In the aesthetic character providing center (100), arbitrary image pattern data (1) and data of arbitrary various characters (3) are mainly accumulated and stored as described above.

In many of ordinary cases, a local area network (LAN) (102), a workstation (WS) (101), and a printer (18) are prepared. Further, the WS (101) includes an input/output system (103) which receives information on an aesthetic character request from the user or member (6), or provides the aesthetic character request, an analysis system (104) which grasps the request information, a control system (105), and a selection system (106).

Thus, on the basis of the input, the main server (10) attaches classification (codes) as will be described below to the inputted characters to perform analysis (26) in a manner of a thesaurus. The accumulated arbitrary characters (4) are retrieved (27) on the screen (23) so as to make their strokes displayed (28). When the result of the determination (29) is No (30) and the inputted characters need to be corrected, a character correcting operation (31) is performed by inputting characters (25) with the keyboard.

At this time, in the main server (10), a number of arbitrary image patterns (2) are classified beforehand on the basis of codes corresponding to images, motifs and other industrial fields of the image patterns so as to be inputted as the arbitrary image pattern data (1). Then, when the result of the above described determination (29) is YES (32), the user or member (6) selects the arbitrary image pattern (2) that the user or member desires, and clicks (33) the image pattern. Thereby, in the main server (10), the arbitrary image pattern (2) is made to be synthesized (34) with the arbitrary characters (4), so that the resultant image pattern is subjected to subsequent processing and thereafter displayed (35) on a preview screen. Then, the user or member performs an operation relating to image processing (21).

At this time, it is interesting to enable the user or member (6) to perform the operation in such a manner that the characters (4) and the image pattern (2) are completed and synthesized, while the operating process is displayed in a sequential and, possibly, intermittent manner on the screen (23) of the terminal (12) operated by the user or member (6).

In other words, when an image pattern interesting for the user or member is generated during the operating process in which the characters and the image patterns are shifted so as to be synthesized with each other, the user or member (6) makes the image pattern in that state as a still image, to make the still image displayed on the screen or to make a hard copy of the still image, thereby obtaining characters of a desired image pattern.

Then, the user or member determines (36) whether or not the synthesized aesthetic image pattern bodies are satisfactory. When the result is unsatisfactory to the user or member (6), that is, NO (37), the user or member (6) returns the image pattern (2) to the reselection (38) process followed by the image pattern selection (33) process. This operation is continued until the user or member (6) is satisfied. When the result is satisfactory to the user or member (6), that is, YES (38), the user or member (6) clicks the final decision (40) and completes the synthesizing process (41) by storing the resultant image pattern, or the like. Then, the user or member (6) makes the resultant image pattern displayed (42) on the monitor as an outputting section, so as to make the image pattern delivered as it is to the other users or outputted as a hard copy.

However, in many cases, the arbitrary various characters (3) requested by the user or member (6) are handled by a fixed amount of collective sentences. For this reason, when the characters (3) are once acquired by the user or member (6), unbalance is generated between the case where the operating rate of the main server (10) is high and the case where the operating rate of the main server (10) is low, which may result in a trouble for other users or members (6).

Therefore, in the main server (10), it is necessary to take a countermeasure of providing a subfront server which controls such collective characters (3), or the like.

In addition, the so-called calligraphic type corresponding to the Ming type and the Gothic type is preferably provided for the above described characters (4) in the main server (10), but cannot often be provided due to the restriction of hardware and software in the main server (10). For this reason, in the main server (10) according to the embodiment of the present invention, there is incorporated a system capable of judging the contents of service that can be performed by the server in correspondence with the information of characters (4) inputted by the user or member (6), and informing the user or member (6) of the contents of the judgment.

Further, the system includes a program which enables original image patterns (2) created by the user or member (6) and the like, or arbitrary various characters (4), to be registered (15) in the original list (3) of the main servers (10) and stored, so that it is possible for the user or member and the like of this system to easily input and store even image patterns created by themselves in the system, and to retrieve the image patterns when necessary. Further, it is possible to consider means which allows those other than the creators of the image patterns to output the image patterns, and which makes the image patterns free of charge for the creators of the image patterns, and charged for those other than creators.

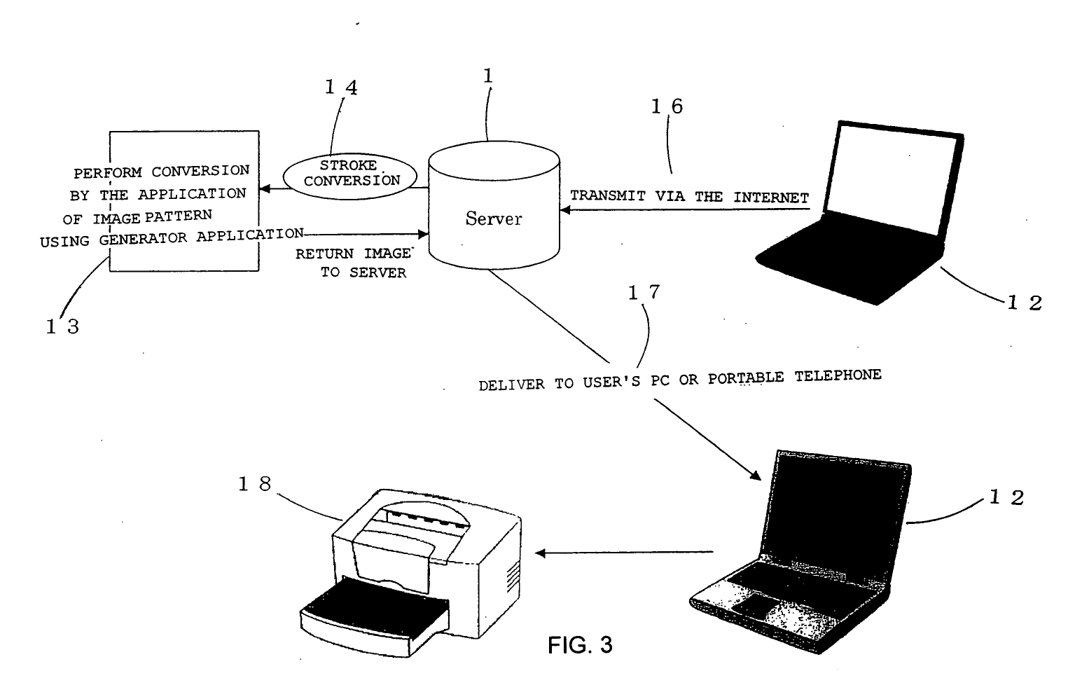

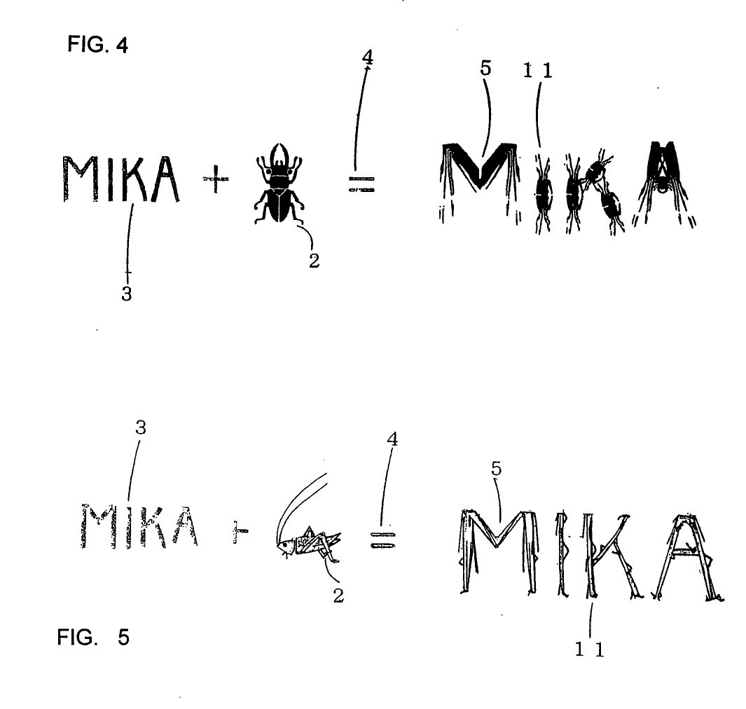

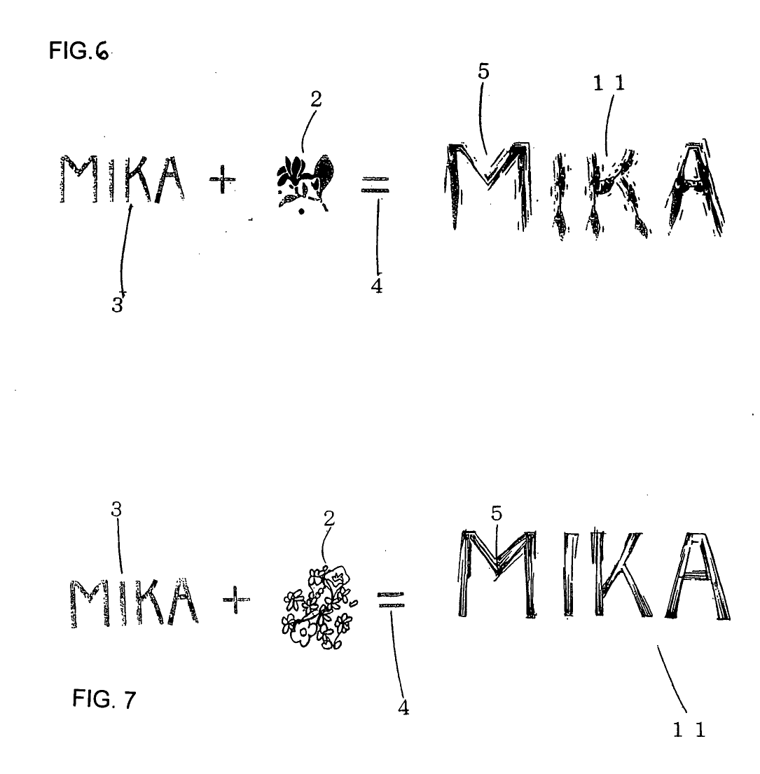

In this way, the user or member (6) is a user of the system and at the same time, is a creator who inputs the data (1) of various image patterns (2) in the main server (10), and hence, it is possible for the user or member (6) to have great interests in the system by making the user or member (6) a member for building the system. In FIG. 3, reference numeral (13) denotes a generator application capable of effecting conversion by applying an arbitrary image pattern (2) selected from the main server (10) via the stroke conversion (14) system to arbitrary various characters (4), and returning a resultant image to the main server (10).

Note that it is necessary to use dedicated stroke character data for the processing of the various image patterns (2) and the data (1) of the image patterns. Thus, the system makes it possible for the user or member (6) or the like to immediately retrieve a desired image pattern from the arbitrary image patterns (2) stored in the pattern database of the main server (10). Further, the system makes it possible for the image patterns (2) created by the user or member (6) or the like, to be transmitted (16) from the terminal (12) of the user or member (6) or the like to the pattern data (1) of various image patterns in the main server (10) via the Internet (16) or the like.

Thus, a system is separately provided, which makes it possible for the user or member (6) to deliver (17) and purchase desired character bodies (5), by accessing the main server (10) from their terminal (12). In this way, the video images displayed on the monitor of the terminal (12) of the user or member (6), or aesthetic character bodies printed and drawn by the printer (18) of the terminal (12) can be applied to all characters including, characters uniquely and showily designed for attracting public attention, which are used, for example in the television broadcast, for a title of the top section of a program, and for a telop and flip for providing an effect in the program, and characters used for a heading and a title of contents on a site of the Internet or the like utilized by various groups such as a broadcasting station, a newspaper publishing company, a publisher, and individuals, and for a heading and a title of a journal, a newspaper, an advertisement, a signboard, or the like, as a result of which it is possible to provide unique and showy character styles in respective parts desired to be emphasized, to thereby guarantee a big business.

It should be noted for the sake of confirmation that the various arbitrary image patterns (2) include motifs themselves besides video images of real objects and various rough sketches and illustrations of the real objects, and preferably include graphics in wide variety of fields, such as: graphics or the like which are classified into the fields of living matters and the nature, and which are represented in conjunction with various plants, animals, human being; graphics or the like which are classified into the field of technology, and which are represented in conjunction with various electronics besides computer apparatuses, the Internet and technologies, and which are represented in conjunction with traffic, railroads, motor vehicles, various kinds of buildings and materials, information, communication, resources, and nuclear energy, or the like; graphics or the like which are represented as social phenomena, and which are represented in conjunction with politics, administration, economy, education, history, welfare, occupation, peace, war and military affairs, medical science, or the like; graphics or the like which are classified into the fields of art and culture, and which are represented in conjunction with language, food, religion, entertainments, life, amusement, literature, music, fine arts, stages, art, cinema, animation, sport, games, media, television, radio, books, custom, tradition, annual events, horoscopy, or the like; graphics or the like which are classified into the field of technology, and which are represented in conjunction with computers, the Internet, technology, electronics, traffic, railroads, motor vehicles, buildings, information, communication, resources, and nuclear energy, or the like; and graphics or the like which are classified into the field of nature, and which are represented in conjunction with materials, energy, space, the earth, environment, weather, disaster, ocean, continents, islands, celestial bodies, or the like.

Further, the arbitrary image patterns (2) inputted into this pattern database (1) are provided with codes based on a fixed rule, such as the classification by the fields relating to the image patterns, so as to enable the images or the like to be outputted on the basis of the codes. It is preferred to use proper nouns consisting of only words meant by the image patterns, for the classification of the kind of the image patterns. In this case, a first character of the proper noun (a first syllable expressed by the Japanese syllabary in the case of Japanese) is preferably selected as means for classifying or retrieving the image patterns. Thereby, the meaning of one word is imparted to one image pattern, which may simply be referred to as a word image pattern.

Further, in the present embodiment, it is necessary to devise so that an image pattern formed by the combination of several kinds of image patterns, such as the combination of two image patterns, can be utilized by being classified into the fields relating to the respective words meant by the image patterns, in such a manner that, for example, an image pattern of “a tiger and bamboo” is classified into the higher concepts of animal and plant, like a thesaurus.

Further, the word image pattern is generally classified into a range of a word which can be read directly and uniquely from the image pattern, but in an image pattern (2), such as for example a psychedelic image pattern, the range meant by the image pattern exceeds the range of the image pattern itself. The meaning of such image pattern may be sometimes understood only by viewing the image pattern, but in many cases, the meaning of the image pattern cannot be understood only by viewing the image pattern. In this case, it is necessary to create a field into which such image pattern can be classified.

As for an image pattern whose meaning can be understood only by members of a specified group with mutual understanding between the members, or by specified individuals capable of communicating with each other, it is preferred to constitute such image pattern by using Postscript (trade mark) for Macintosh or True Type (trade mark) for Windows, in order to make the image pattern usable as the image pattern according to the present invention. The database of a set of the image patterns for such group, which are ranked high in the classification of image patterns like a thesaurus, is provided as required. Among a number of image patterns registered in the common image pattern database, the image patterns used only by the specific group are transmitted in a set as they are, and registered and stored in the main server (10).

Since the registered and stored image patterns are used as a common language within the specific group, it is preferred to prevent the set of the image patterns from being used by the other groups. For example, for the use of the set of the specific image patterns, it is preferred to attach an identification number (ID) and a password to the set of the image patterns. In this way, according to the present embodiment, the retrieving means enables an image pattern to be retrieved by a plurality of initial sounds of words, so that the retrieving operation can be quickly and surely performed. In addition, arbitrary image patterns are classified into higher concepts, synonyms and lower concepts, in a manner of a so-called thesaurus, thereby facilitating the narrowing down into a desired image pattern. Further, the retrieving means is capable of retrieving the image pattern with a plurality of initial sounds of words, so that the retrieving operation can be quickly and surely performed. In addition, arbitrary image patterns are classified into higher concepts, synonyms and lower concepts, in a manner of a so-called thesaurus, thereby facilitating the narrowing down into a desired image pattern.

Further, the system according to the present embodiment is constituted in such a manner that the arbitrary image patterns not retrieved (not used) for a fixed period of time can be deleted from the pattern database (server), while the image patterns such as those reflecting the age can be easily inputted.

Further, it is necessary that the arbitrary image pattern (2) data inputted into the above described pattern database (1) are hierarchically classified and registered for each image pattern (2) data, and that when an arbitrary pattern (2) is retrieved from the pattern (2) data, the arbitrary pattern (2) can be retrieved from a plurality of initial sounds of words meaning the arbitrary pattern (2). Further, in the image patterns (2) registered in the above described image pattern (2) database, for example, chargeable image patterns (2) which are shared by specific users or members such as copyright holders, and image patterns (2) for nonchargeable groups are registered, so that the users or members of the respective groups are allowed to selectively utilize the image patterns in the image pattern (2) database, which are allowed only for the respective groups.

Further, as for the arbitrary image pattern (2) data inputted into the above described pattern database (1), it is necessary to provide database maintenance means not only for registering a newly created image pattern (2) but also for deleting image patterns (2) no longer used from the image pattern database (1) and modifying the image patterns (2).

Further, the image pattern database maintenance means is provided as required and performs maintenance operations of the image patterns as data of the image pattern database (1) or the group image pattern set database 3. The contents of the maintenance operations include the registering of newly created image patterns into the image pattern database or the group image pattern set database, and the deleting of the image patterns no longer used from the common image pattern database or the group image pattern set database. It is possible to make the user perform the maintenance operations. However, it is preferred to make a management agent managing the image patterns perform the maintenance operations, so as to prevent the user from accessing the image pattern database maintenance means.

The providing center of aesthetic characters used in the present embodiment, is usually connected to a LAN (local area network) via an IP router, to which LAN the above described main server (10) performing the service for providing the characters, a WS (workstation), a printer and the like are connected.

The WS and the printer serve as a user or member to perform a request of an image pattern to the main server (10). Specifically, the WS requests the image pattern for screen character display to the main server (10), and the printer requests the image pattern for printing to the main server (10).

The main server (10) receives the image pattern request from the WS and the printer serving as the user or member, and transmits the image pattern data corresponding to the image pattern request to the user or member as the request source. Further, a concrete constitution as an embodiment of the main server (10) performing communication with the user or member (6) is explained. The WS is constituted by an input/output system, a situation request system, an image pattern request system, a control system, and a main server (10) selection system.

The input/output system outputs the information request data received from the request system and the image pattern request data received from the image pattern request system, to the LAN, and when receiving the information data or the image pattern data addressed to an apparatus from the LAN, outputs the received data to the control system. In this case, the situation request system is a functional system which performs transmission of the information request data, and when receiving an instruction of the information request from the control system, outputs the information request data to the LAN via the input/output system. At this time, the image pattern request system requests the information selected by the selection system of the main server (10) via the control system.

When receiving a request of image pattern for display from the display processing system, the control system instructs the situation request system to make a situation request to the main server (10) selected by the main server (10) selection system. Then, when receiving the response of information data, the control system judges whether or not to perform the image pattern request to the main server (10). When again making the request of information data to the other main servers (10), the control system issues the selection instruction to the main server (10) selection system.

Further, when receiving the number of the main server (10) reselected by the main server (10) selection system, the control system outputs the number of the main server (10) to the situation request system.

The control system repeats the same processing until the main server (10) to which the image pattern request is made is determined. When the main server (10) to which the image pattern request is made is determined, the control system issues the instruction of the image pattern request to the image pattern request system. When receiving the image pattern data corresponding to the image pattern request from the input/output system, the control system outputs the image pattern data to the display processing system.

The main server (10) selection system is a functional system which performs the selection of the main server (10). Specifically, when the control system receives the image pattern request from the display output system, the main server (10) selection system first performs the first selection of the main server (10). Then, when the control system determines to again request information data to the other main servers (10) on the basis of the received information data, the main server (10) selection system again performs the reselection and outputs the number of the selected main server (10) to the control system.

Similarly, the above described selecting operation is repeated until the main server (10) to be used is determined. In this case, in the reselecting operation of the main server (10), the main server (10) already selected is excluded. Note that in the present embodiment, the main server (10) to which the information data are requested is selected each time the selecting operation is performed, but it is also possible to request the information data to the respective main servers (10) at the beginning, and to determine the main server (10), to which the service request is made, by comparing and considering the respective information data.

Thus, by using the above described constitution, it is possible to make the request of the information data to the main servers (10) prior to the image pattern request, and to select the main server (10) to which the image pattern request is made, on the basis of the information data.

Further, in a step of creating and modifying the image pattern, when an image pattern set is created or modified, utilization means of the center (100) is used by the user or member (6) via the terminal (12). The user or member (6) performs the access for creation and modification to the aesthetic character providing center (100) from the utilization means of the center (100) via the communication network. The aesthetic character providing center (100) to which the access for creation and modification is performed, reads as candidates a plurality of image patterns belonging to the desired genre from the common image patterns registered in the common image pattern database 2 according to the contents of the access. The aesthetic character providing center (100) makes display means of the terminal (12) of the user or member (6) display the plurality of image patterns as candidates, and urges the user or member (6) to select an image pattern desired to be used.

The user or member determines the candidate image pattern by input means. The determination signal is transmitted from the terminal (12) of the user or member (6) to the aesthetic character providing center (100), and the determined candidate image pattern is registered in the group image pattern set database 3. When the step of creating and modifying the image pattern is completed, or when neither creating nor modifying operation is performed, the system proceeds to the next step, and thereafter the above described steps are performed.

Further, in the above described embodiment, a case where an image pattern is converted to meaningful words is explained, but the present invention is not limited to Japanese. For example, the present invention can also be applied to foreign languages, such as English, and as described above, it is also possible to convert the image pattern to the initial sounds (alphabet) of English words meant by the image pattern. Although the image pattern has ethnicity, regionality or the like, it is a globally common character, and hence can be applied even in foreign countries. That is, the image pattern effects communication beyond the race, and hence can be used as a communication tool of intention which is common throughout the world.

As described above, the arbitrary image patterns (2) as examples of the aesthetic character bodies drawn according to the present invention, are formed into continuous and/or discontinuous arbitrary image patterns (2). Such arbitrary various characters include, besides those obtained by representing words of the languages such as Chinese, Indian, Spanish, English, Arabian, French, Japanese, Korean languages with single lines, characters subjected to the emphasizing processing and half-tone dot meshing processing and provided with a side point and a ruby, enclosed characters, and various decorative and colored characters.

In addition, as for means for outputting the above described character bodies, besides various printers and facsimiles, a computer apparatus of a portable type, a desktop type or a mobile type, a portable telephone, a PHS, or a user or member's terminal of a stationary type such as PDA (Personal Digital Assistants) can be applied as the apparatus capable of outputting various characters. Using stroke character data exclusively for the pattern data processing of the various image patterns, for the above described various image pattern data, is also included within the scope of the present invention.

Further, in the case where the above described image patterns are chargeable due to copyright or the like, the system capable of notifying the user or member of the existence and the price of such image patterns, enables the user or member to select the image patterns with ease. Besides image patterns of tangible articles in all fields, intangible motifs, such as those made by using the peace as a theme, are also stored in the image pattern database.

Further, although ordinary characters of languages which are currently used are formed by the combination of single lines or by a single complicated curve, characters according to the present invention are based on single lines, and hence can be applied to the languages of as many countries as those throughout the world. Further, the pattern data processing of various image patterns, according to the present invention, can be quickly and accurately performed by the use of dedicated character data which are excellent in the stroke aesthetic property. Further, the present invention makes it possible for the user or member to view the process, in which image patterns and single lines are successively changed into aesthetic characters as if the image patterns and the single lines are gradually mixed with each other, on a monitor of a PC or the like, to thereby have great interests in the operation for the process.

Note that the present invention is explained mainly in conjunction with characters of the language of each country, but the present invention is not limited to this, the present invention can be applied to symbols, illustrations or the like in which single lines are used, and such application is also included within the scope of the present invention.

Further, as for the input means of various characters, the present invention is not limited to the input means of the printing type of a PC, but may also include an autographic input by using a touch pen.

### FIG. 1

20 INPUT PART
21 IMAGE PROCESSING PART
22 OUTPUT PART
23 MAIN SCREEN
24 CLICK CHARACTER INPUT FIELD
25 INPUT/CONVERT CHARACTER BY KEYBOARD
26 ANALYZE CHARACTER CODE
27 RETRIEVE CORRESPONDING STROKE SINGLE LINE CHARACTER DATA
28 DISPLAY STROKE FONT
29 DETERMINATION
31 CHARACTER CORRECTION OR THE LIKE
33 SELECT IMAGE PATTERN TO BE APPLIED
34 SYNTHESIZE SINGLE LINE CHARACTER WITH IMAGE PATTERN
35 DISPLAY PREVIEW SCREEN AFTER PROCESSING
36 DETERMINATION
38 RESELECT IMAGE PATTERN
40 DETERMINATION
41 SYNTHESIZING PROCESS
42 DISPLAY PROCESSED RESULT ON MONITOR
#1 FLOW CHART OF PICTOGRAM PROCESSING

### FIG. 2

4, 3, 9 ORIGINAL LIST
6 CHARGEABLE MEMBER, NONCHARGEABLE MEMBER
7 USE, PAYMENT OF CHARGE AND REGISTRATION
8 PAYMENT OF CHARGE AND REGISTRATION
15 REGISTER OWN ORIGINAL
#1 NONCHARGEABLE MEMBER
#2 CHARGEABLE MEMBER

### FIG. 3

13 PERFORM CONVERSION BY THE APPLICATION OF IMAGE PATTERN USING GENERATOR APPLICATION
14 STROKE CONVERSION
16 TRANSMIT VIA THE INTERNET
17 DELIVER TO USER'S PC OR PORTABLE TELEPHONE
#1 RETURN IMAGE TO SERVER

### FIG. 18

1 Image Pattern Data
3 CHARACTER DATA
12 USER TERMINAL
100 AESTHETIC CHARACTER PROVIDING CENTER

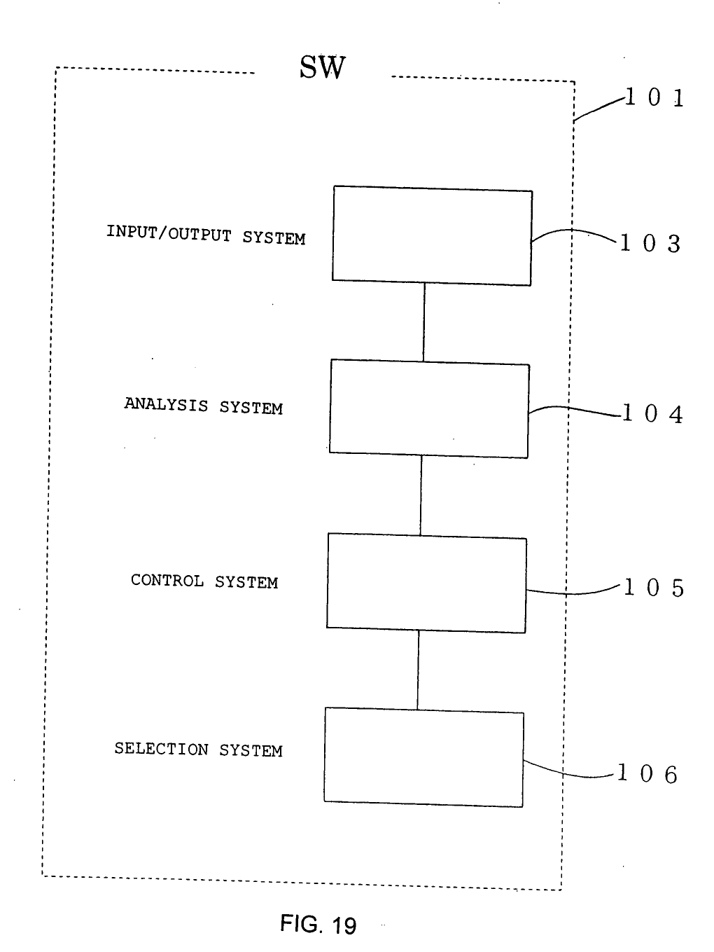

### FIG. 19

103 INPUT/OUTPUT SYSTEM
104 ANALYSIS SYSTEM
105 CONTROL SYSTEM
106 SELECTION SYSTEM

1. A method for generating aesthetic characters, comprising: selecting an arbitrary image pattern from a pattern database of various image patterns stored; processing the arbitrary image pattern into various arbitrary characters constituted by single lines by superposing data of the arbitrary various characters on the image pattern; and enabling an image pattern character to be generated and outputted.

2. A system for generating aesthetic characters, comprising: means for selecting an arbitrary image pattern from a pattern database of various image patterns stored; means for superposing data of arbitrary various characters constituted of single lines on the selected image pattern; means for processing the selected arbitrary image pattern into arbitrary various characters, and enabling a desired image pattern character to be generated and outputted.

3. A business model for generating aesthetic characters, comprising: means for selecting an arbitrary image pattern from a pattern database of various image patterns stored; means for superposing data of arbitrary various characters constituted of single lines on the selected image pattern; means for processing the selected arbitrary image pattern into arbitrary various characters; means for generating and outputting a desired image pattern character and/or a desired font; a main server of image patterns, having an original list, on the basis of which registration of the image pattern characters and/or the user or member and payment of the price of the image pattern characters, or the like, are performed, and having data of the various image patterns; and a terminal for the user or member, having a function to enable an image pattern created by the user or member to be inputted into the pattern data of the image patterns.

4. A method and system for generating aesthetic characters, and a business model of the same, wherein a main server of image patterns includes a generator application besides pattern data of various image patterns, wherein an image pattern created by a user or member is inputted into the pattern data of the various image patterns in the main server by using the Internet or the like, wherein the pattern data are subjected to image processing in which the image pattern data are converted by the application of the image pattern through a stroke image pattern or the like with the generator application, and wherein the processed image is returned to the main server, and according to an access by the user or member, delivered to terminals such as a PC of the user or member.

5. The business model for generating aesthetic characters, according to claims 1 to 4, wherein the user or member is a user, and at the same time, a creator who inputs pattern data of various image patterns into the main server.

6. The method and system for generating aesthetic characters, and the business model of the same, according to claims 1 to 4, wherein arbitrary image patterns inputted into the pattern database are provided with codes based on a fixed rule such as classification by fields relating to the image patterns, to make images or the like outputted on the basis of the codes.

7. The business model for generating aesthetic characters, according to claims 1 to 4, wherein the pattern data of arbitrary image patterns inputted into the pattern database are hierarchically classified and registered for each data of image pattern, and are registered in a manner that when an arbitrary pattern is retrieved from the pattern data, a plurality of initial sounds of words meaning the pattern can be retrieved.

8. The business model for generating aesthetic characters, according to claims 1 to 4, further comprising database maintenance means for enabling a newly created image pattern to be registered, and for enabling, among arbitrary image pattern data inputted into the pattern database, an image pattern that is no longer used, to be deleted from the pattern database or to be modified.

9. The business model for generating aesthetic characters, according to claims 1 to 4, wherein in the image patterns registered in the image pattern database, chargeable image patterns shared only by a group of specific users or members such as copyright holders, and image patterns for a nonchargeable group are registered, and wherein the users or members of each group are allowed to selectively utilize only the image patterns allowed for the group.

10. The method and system for generating aesthetic characters, and the business model of the same, according to claims 1 to 4, wherein the various image pattern data include motifs themselves besides video images of real objects and various rough sketches and illustrations of the real objects, and include figures, such as: graphics or the like which are classified into the fields of living matters and the nature, and which are represented in conjunction with various plants, animals, human being; graphics or the like which are classified into the field of technology, and which are represented in conjunction with various electronics besides computer apparatuses, the Internet and technologies, and which are represented in conjunction with traffic, railroads, motor vehicles, various kinds of buildings and materials, information, communication, resources, and nuclear energy, or the like; graphics or the like which are represented as social phenomena, and which are represented in conjunction with politics, administration, economy, education, history, welfare, occupation, peace, war and military affairs, medical science, or the like; graphics or the like which are classified into the field of art and culture, and which are represented in conjunction with language, food, religion, entertainments, life, amusement, literature, music, fine arts, stages, art, cinema, animation, sport, games, media, television, radio, books, custom, tradition, annual events, horoscopy, or the like; graphics or the like which are classified into the field of technology, and which are represented in conjunction with computers, the Internet, technology, electronics, traffic, railroads, motor vehicles, buildings, information, communication, resources, and nuclear energy, or the like; and graphics or the like which are classified into the field of nature, and which are represented in conjunction with materials, energy, space, the earth, environment, weather, disaster, ocean, continents, islands, celestial bodies, or the like.

11. A method and system for generating aesthetic characters, and a business model of the same, wherein the arbitrary various characters, according to claims 1 to 4, include those obtained by representing languages such as Chinese, Arabic, Indian language, English, Spanish, Bengali, Portuguese, Russian, Japanese, German, French, and Korean language, with single lines, and also include characters which are subjected to emphasizing processing and half-tone dot meshing processing and provided with a side point and a ruby, and enclosed characters, various decorative and colored characters.

12. A method and system for generating aesthetic characters, and a business model of the same, wherein means for outputting aesthetic character bodies that are drawn by the method and/or the system according to claims 1 to 4, can be applied to various apparatuses capable of outputting various characters, such as various printers and facsimiles, as well as a computer apparatus of a portable type, a desktop type or a mobile type, a portable telephone, a PHS, and a user or member's terminal of a stationary type such as PDA (Personal Digital Assistants).

13. The method and system for generating aesthetic characters, and the business model of the same, according to claims 1 to 4, wherein stroke font data exclusive for pattern data processing of the various image patterns are used for the various image pattern data.

14. The method and system for generating aesthetic characters, and the business model of the same, according to claims 1 to 4, wherein the means for superposing (synthesizing) data of arbitrary various characters constituted of single lines on the selected image pattern, displays the synthesizing process on a monitor of a PC or the like with dynamic images.

15. A method and system for generating aesthetic characters, and a business model of the same, wherein a plurality of arbitrary image patterns are selected from the arbitrary image patterns according to claims 1 to 4, and data of arbitrary various characters constituted of single lines are superposed on the plurality of arbitrary image patterns.

16. A method and system for generating aesthetic characters, and a business model of the same, wherein the means for selecting an arbitrary image pattern and superposing the selected image pattern on data of arbitrary various characters, according to claims 1 to 4, is capable of arranging a part of the image pattern at a desired position of the characters.

17. A method and system for generating aesthetic characters, and a business model of the same, wherein the aesthetic character bodies drawn by the method and/or the system according to claim 1 to 4, is constituted in a manner that an arbitrary image pattern is formed into a continuous and/or discontinuous arbitrary image pattern.

18. A method and system for generating aesthetic characters, and a business model of the same, wherein the aesthetic character bodies drawn by the method and/or the system according to claims 1 to 4, are drawn in a manner that all or part of arbitrary various characters are formed into an arbitrary image pattern.
